(19) United States
(12) Patent Application Publication
(10) Pub. No.: US 2016/0178040 A1
(43) Pub. Date: Jun. 23, 2016

(54) DRIVE ASSEMBLY FOR MACHINES

(71) Applicant: Caterpillar Inc., Peoria, IL (US)

(72) Inventor: Brandon L. Hagman, Decatur, IL (US)

(73) Assignee: Caterpillar Inc., Peoria, IL (US)

(21) Appl. No.: 15/058,160

(22) Filed: Mar. 2, 2016

(51) Int. Cl. F16H 37/08

(52) U.S. Cl. CPC F16H 37/082

(57) ABSTRACT

A drive assembly for machines is provided, which includes a differential gear arrangement and at least one final drive arrangement. The differential gear arrangement includes at least one differential output shaft. The final drive arrangement is driven by the differential output shaft. The final drive arrangement includes a primary planetary gear assembly, a secondary planetary gear assembly, and a clutch. The primary planetary gear assembly includes a first sun gear powered by differential output shaft, a first planetary gear, a first ring gear kept stationary, and a first planetary carrier fixed to a wheel drive mechanism. The secondary planetary gear assembly includes second sun gear powered by the differential output shaft, second planetary gear, second ring gear, and second planetary carrier fixed to the wheel drive mechanism. The clutch partially engages and disengages with the second ring gear, to correspondingly partially restrict and release the second ring gear.

### TECHNICAL FIELD

The present disclosure relates generally to drive assemblies for machines. More specifically, the present disclosure relates to torque vectoring in a drive assembly of a machine, with use of a primary planetary gear assembly applied in conjunction with a secondary planetary gear assembly of a final drive arrangement.

### BACKGROUND

Machines, such as motor graders, are commonly known to employ two frontal wheels and two rear wheel pairs. Each of the two rear wheel pairs are individually installed to sides of the machine. Such machines include drive assemblies that drive each of these rear wheel pairs to facilitate machine travel and maneuverability. These drive assemblies generally include a differential gear arrangement that drives each of the two rear wheel pairs, by way of individual final drive arrangements and individual tandems.

During several operational instances, such as when ground engaging tools (GETs) of the machine, for example blades, are required to operate at an angle relative to the direction of the machine's motion, GETs sustain a reactive angular side-load relative to a desired travel direction. Therefore, an unwarranted turning moment is developed in the machine, which may cause wheel slippage and wheel wear. In order to counter this turning moment, a steering mechanism is conventionally operated, to steer the frontal wheels at an angle relative to the travel direction. This imparts a counter turning moment on the machine and facilitates machine maneuver in a straight direction, along the travel direction. However, such a manipulation requires a continuous operator intervention and imparts stresses on a frame of the machine. This results in wastage of energy and power, and is generally commensurately beset with frequent visits for service and repairs owing to the associated consequential issues of wear and tear. In addition, wastage of energy corresponds to reduction in overall efficiency of the machine.

U.S. Pat. No. 7,601,089 discloses a drive mechanism of a drive axle assembly for use in a motor vehicle. The drive mechanism includes a differential, a speed changing unit, a first mode clutch, a second mode clutch, and a brake unit. The brake unit, in conjunction with the speed changing unit and the first clutch, has the ability to decrease a speed of the first axle shaft, and correspondingly speed of the first pair of wheel. As aforementioned, braking a wheel pair to transmit additional torque to an opposite wheel pair reduces an overall efficiency and restricts the procedure from being an efficient measure to counter side-loads. Moreover, with the accompanied consumption of more power, room for improvements exist in effectively and efficiently addressing requirements of additional torque transmission to different wheel pairs.

Accordingly, the system and method of the present disclosure solves one or more problems set forth above and other problems in the art.

### SUMMARY OF THE INVENTION

Various aspects of the present disclosure describe a drive assembly for a machine. The drive assembly includes a differential gear arrangement and at least one final drive arrangement. The differential gear arrangement includes at least one differential output shaft. The final drive arrangement is connected to and driven by the differential output shaft. The final drive arrangement includes a primary planetary gear assembly, a secondary planetary gear assembly, and a clutch. The primary planetary gear assembly includes a first sun gear, at least one first planetary gear, a first ring gear, and a first planetary carrier. The first ring gear is stationary. The first sun gear is powered by the differential output shaft. The first planetary carrier is fixedly attached to a wheel drive mechanism. The secondary planetary gear assembly includes a second sun gear, at least one second planetary gear, a second ring gear, and a second planetary carrier. The secondary planetary gear assembly possesses a lower gear ratio relative to the primary planetary gear assembly. The second sun gear is connected to and powered by the differential output shaft. The second planetary carrier is fixedly connected to the wheel drive mechanism. The clutch is adapted to at least partially engage and disengage with the second ring gear, to correspondingly at least partially restrict and release the second ring gear of the secondary planetary gear assembly.

### BRIEF DESCRIPTION OF THE DRAWINGS

FIG. 1 is a perspective view of an exemplary machine, in accordance with the concepts of the present disclosure;

FIG. 2 is a perspective view of a rear frame assembly of the machine that supports a drive assembly of the machine, in accordance with the concepts of the present disclosure;

FIG. 3 is a cross-sectional view of a left hand side (LHS) portion of the drive assembly that illustrates a differential gear arrangement, a final drive arrangement, and a tandem of the drive assembly of FIG. 2, in accordance with the concepts of the present disclosure;

FIG. 4 is a schematic of the left hand side (LHS) portion of the drive assembly of FIG. 2 that illustrates an arrangement of an additional planetary gear assembly in the final drive arrangement, in accordance with the concepts of the present disclosure; and

FIG. 5 is a schematic of an alternate embodiment of the wheel drive mechanism of the tandem of the drive assembly of FIG. 2, in accordance with the concepts of the present disclosure.

### DETAILED DESCRIPTION

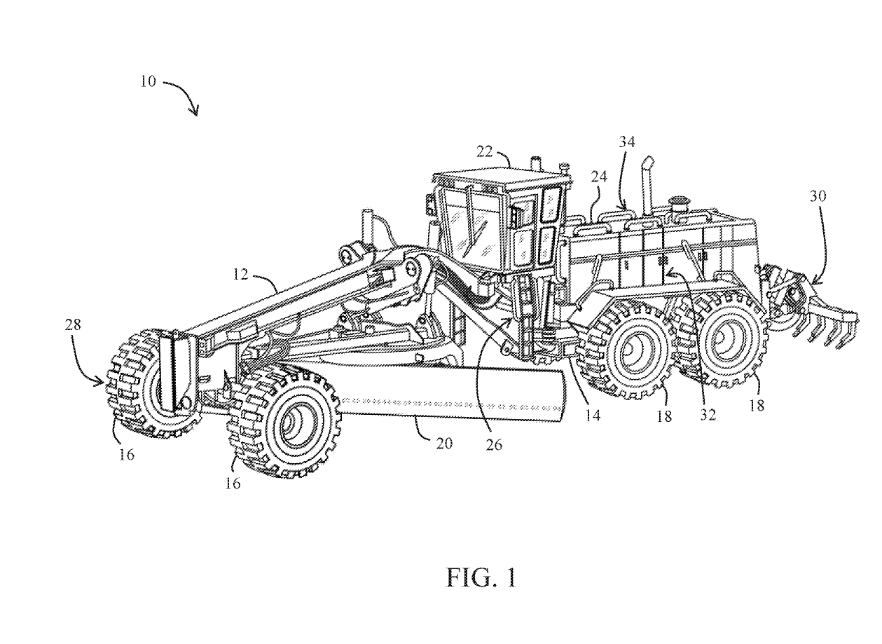

Referring to FIG. 1, there is shown an exemplary machine 10. The machine 10 is a motor grader 10 that facilitates levelling of a ground surface, during a grading operation. Although, the machine 10 is shown as the motor grader 10 in the present disclosure, various other types of the machine 10 may also be contemplated. Examples of the machine 10 may include, such as but not limited to, a mining truck, a forestry machine, a wheel loader, a shovel, and a backhoe loader. For ease in reference and understanding, the machine 10 will be referred to as the motor grader 10, interchangeably hereinafter. The motor grader 10 includes a frontal frame 12, a rear frame assembly 14, two frontal wheels 16, four rear wheels 18 (two of which are shown in FIG. 1), a blade 20, an operator cabin 22, an engine compartment 24, and a drive assembly 26.

The frontal frame 12 is an elongated structure positioned proximal to a frontal end 28 of the motor grader 10. The frontal frame 12 is steerable, relative to the rear frame assembly 14 of the motor grader 10. The frontal frame 12 is adapted to rotatably support the blade 20 of the motor grader 10 that levels the ground surface, while performing the grading operation. The blade 20 is generally rotatably positioned at an angle, relative to a direction of motion of the motor grader 10. Additionally, the frontal frame 12 rotatably supports the frontal wheels 16 of the motor grader 10.

The rear frame assembly 14 is a rear support structure positioned proximal to a rear end 30 of the motor grader 10 and is rotatably attached to the frontal frame 12. The rear frame assembly 14 is adapted to support the operator cabin 22 and the engine compartment 24 of the motor grader 10. An operator is generally positioned in the operator cabin 22, to access a number of control circuitries (not shown) associated with the motor grader 10. Additionally, the rear frame assembly 14 supports the rear wheels 18 that facilitate machine maneuvering, during the grading operation.

In the current embodiment, the motor grader 10 includes two frontal wheels 16 and four rear wheels 18. One frontal wheel 16 is rotatably installed on a first side 32 of the motor grader 10 and other frontal wheel 16 is rotatably installed on a second side 34 of the motor grader 10. Similarly, two rear wheels 18 are rotatably installed on the first side 32 of the motor grader 10 and other two rear wheels 18 are rotatably installed on the second side 34 of the motor grader 10. Further, the rear wheels 18 are connected to and powered by the drive assembly 26, to maneuver the motor grader 10 forward.

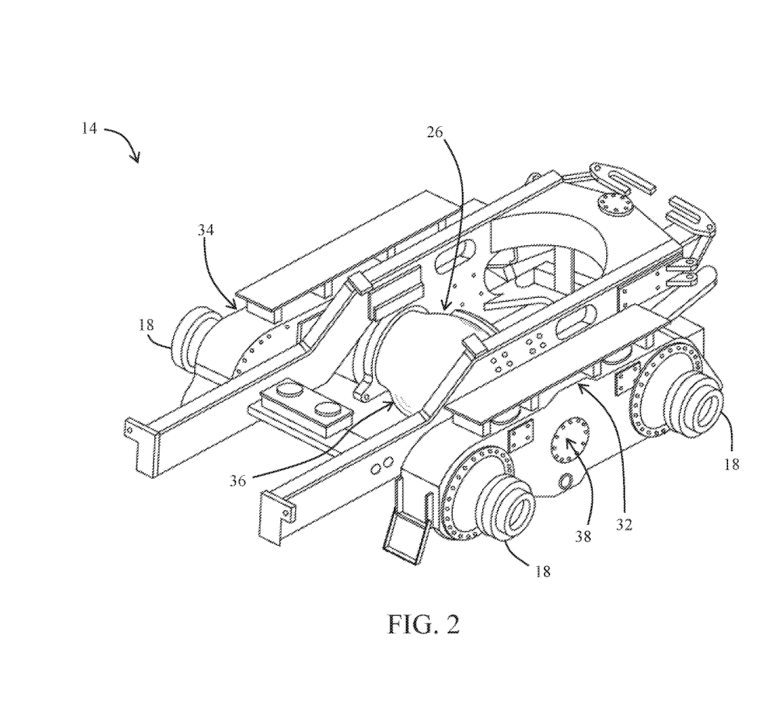

Referring to FIG. 2, there is shown a perspective view of the rear frame assembly 14 that illustrates the drive assembly 26 of the motor grader 10. The drive assembly 26 is operably connected between the engine (not shown) and the rear wheels 18. The drive assembly 26 is adapted to transmit engine torque from the engine (not shown) to the rear wheels 18 on each of the first side 32 and the second side 34 of the motor grader 10. Moreover, the drive assembly 26 is adapted to facilitate selective engine torque transmission from the engine (not shown) to the rear wheels 18 installed on each of the first side 32 and the second side 34 of the motor grader 10. This phenomenon of selective torque transmission to the rear wheels 18 installed on each of the first side 32 and the second side 34, is termed as “torque vectoring” in the motor grader 10.

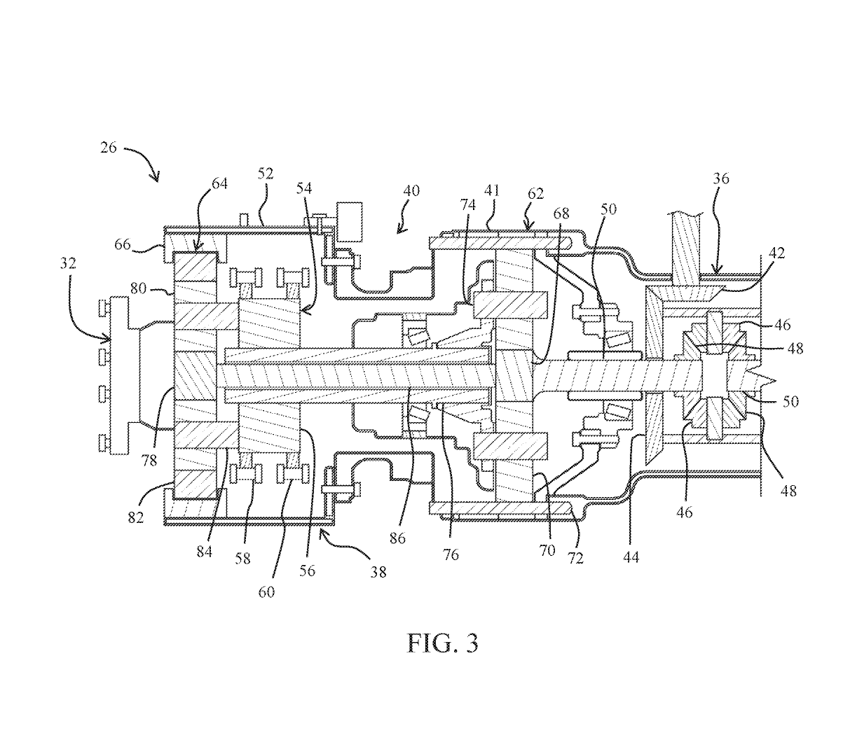

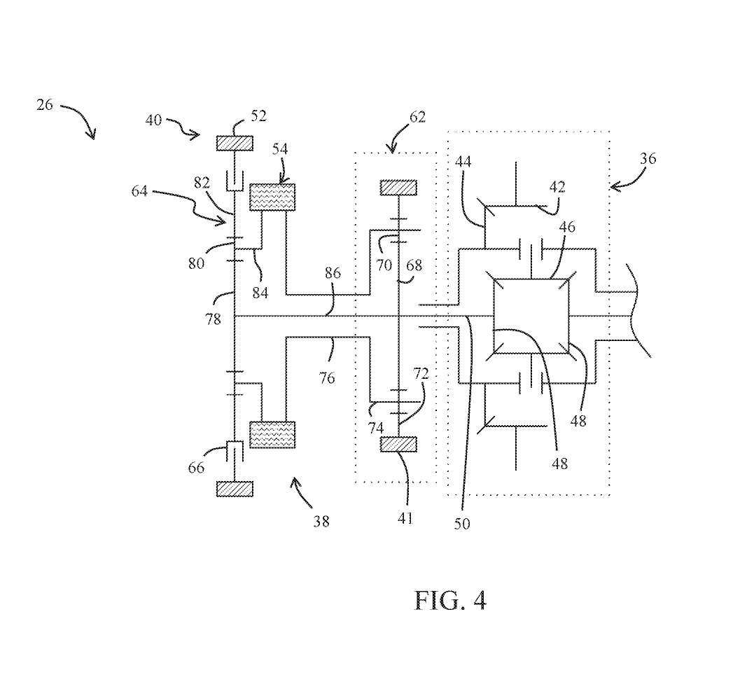

Referring to FIGS. 3 and 4, there is shown an LHS portion of the drive assembly 26 of the motor grader 10. The drive assembly 26 includes a differential gear arrangement 36, two tandems 38, and two final drive arrangements 40. In the current embodiment, the drive assembly 26 employs the differential gear arrangement 36, in conjunction with, an individual final drive arrangement 40 and an individual tandem 38, to drive the rear wheels 18 on each of the first side 32 and the second side 34 of the motor grader 10. Although, structure and arrangement between the differential gear arrangement 36, the final drive arrangement 40, and the tandem 38, to drive the rear wheels 18 installed on the first side 32, will be described hereinafter. Similar structure and arrangement between the differential gear arrangement 36, another final drive arrangement (not shown), and another tandem (not shown), to drive the rear wheels 18 installed on the second side 3′4, may also be contemplated.

The differential gear arrangement 36 is installed within an axle housing 41. The differential gear arrangement 36 includes a pinion gear 42, a crown gear 44, two or more spider gears 46, two side gears 48, and two differential output shafts 50. The pinion gear 42 is connected to the engine (not shown) and is adapted to receive the engine torque. More specifically, the pinion gear 42 is rotated, upon actuation of the engine (not shown). The pinion gear 42, the crown gear 44, the spider gears 46, and the side gears 48 are arranged in a specific manner, such that a rotational motion of the pinion gear 42 corresponds to a rotational motion of the side gears 48. Each of the two differential output shafts 50 are connected to and driven by each of the two side gears 48. Notably, the two differential output shafts 50 of the differential gear arrangement 36 rotate at the same speed, in a locked position of the differential gear arrangement 36. Although, structure and arrangement of a singular differential output shaft 50 with the final drive arrangement 40 and the tandem 38, to power the rear wheels 18 installed on the first side 32 of the motor grader 10, will be described hereinafter. Similar structure and arrangement of the other differential output shaft 50 with the other final drive arrangement (not shown) and the other tandem (not shown), to power the rear wheels 18 installed on the second side 34 of the motor grader 10, may also be contemplated.

The tandem 38 is positioned outboard of the differential gear arrangement 36. The tandem 38 connects to and drives the rear wheels 18 installed on the first side 32 of the motor grader 10. The tandem 38 includes a tandem housing 52 and a wheel drive mechanism 54. The wheel drive mechanism 54 is a chain drive mechanism positioned within the tandem housing 52. The wheel drive mechanism 54 is drivingly connected to the rear wheels 18 of the motor grader 10. The wheel drive mechanism 54 includes a base member 56 (FIG. 3), a first chain member 58 (FIG. 3), and a second chain member 60 (FIG. 3). Each of the first chain member 58 (FIG. 3) and the second chain member 60 (FIG. 3) are chain sprockets fixedly mounted on the base member 56 (FIG. 3) and are rotatably connected to each of the rear wheels 18. The first chain member 58 (FIG. 3) and the second chain member 60 (FIG. 3) are connected to the rear wheels 18, via a chain arrangement (not shown). Therefore, a rotational motion of any of the base member 56 (FIG. 3), the first chain member 58 (FIG. 3), and the second chain member 60 (FIG. 3) corresponds to a rotational motion of the rear wheels 18 of the motor grader 10. The base member 56 of the wheel drive mechanism 5′4 is driven by the differential output shaft. 0.50 via the final drive arrangement 40, which in turn drives the rear wheels 18. Although, the present disclosure contemplates usage of the tandem 40 in the motor grader 10, to drive the two rear wheels 18. Applicability to various other machines that employs a singular rear wheel on each of the first side 32 and the second side 34, may also be contemplated. For such applications, the singular rear wheel is directly driven by the differential output shaft 50, via the final drive arrangement 40.

The final drive arrangement 40 is connected to and driven by the differential output shaft 50 of the differential gear arrangement 36. The final drive arrangement 40 includes a primary planetary gear assembly 62, a secondary planetary gear assembly 64, and a clutch 66. In normal operating conditions of the motor grader 10, the base member 56 of the wheel drive mechanism 54 is driven by the differential output shaft 50, via the primary planetary gear assembly 62. In side loaded operating conditions of the motor grader 10, the base member 56 of the wheel drive mechanism 54 is driven by the differential output shaft 50, via a combination of the primary planetary gear assembly 62 and the secondary planetary gear assembly 64.

The primary planetary gear assembly 62 is a conventional epicyclic gear train positioned within the axle housing 41, outboard of the differential gear arrangement 36. The primary planetary gear assembly 62 includes a first sun gear 68, a number of first planetary gears 70 (two of which are shown in FIGS. 3 and 4), a first ring gear 72, and a first planetary carrier 74. The first sun gear 68 is attached to and powered by the differential output shaft 50. Additionally, the first ring gear 72 is fixedly attached to the axle housing 41 and is therefore kept stationary. A rotational motion of the first sun gear 68 corresponds to a rotational motion of the first planetary carrier 74. Moreover, the first planetary carrier 74 is attached to the base member 56 (FIG. 3) of the wheel drive mechanism 54, via a co-axial drive shaft 76. Therefore, a rotational motion of the first planetary carrier 74 corresponds to a rotation of the base member 56 (FIG. 3) of the wheel drive mechanism 54 and correspondingly the rear wheels 18, installed on the first side of the motor grader 10.

The secondary planetary gear assembly 64 is also conventional epicyclic gear train positioned within the tandem housing 52, outboard of the wheel drive mechanism 54. The secondary planetary gear assembly 64 possesses a different gear ratio than the primary planetary gear assembly 62 does. In the current embodiment, the secondary planetary gear assembly 64 possesses a relatively lower gear ratio than the primary planetary gear assembly 62 does. The secondary planetary gear assembly 64 includes a second sun gear 78, a number of second planetary gears 80 (two of which are shown in FIGS. 3 and 4), a second ring gear 82, and a second planetary carrier 84. The second sun gear 78 is attached to and powered by the differential output shaft 50, via an extension shaft 86. The second ring gear 82 is adapted to operate in a free state and a partially restricted state, with use of the clutch 66. In the free state, the second ring gear 82 rotates freely and minimal rotational torque is transferred from the differential output shaft 50 to the second planetary carrier 84 of the secondary planetary gear assembly 64. In the partially restricted state, the clutch 66 applies a resistance to the rotational motion of the second ring gear 82, to facilitate a slipping motion of the second ring gear 82 relative to the clutch 66. The resistance to rotational motion of the second ring gear 82 facilitates the second planetary carrier 84 to receive substantial amount of torque from the differential output shaft 50. More specifically, as the secondary planetary gear assembly 64 possesses a lower gear ratio than the primary planetary gear assembly 62, the second planetary carrier 84 attempts to rotate at a higher speed than the first planetary carrier 74. This facilitates the second planetary carrier 84 to receive substantial amount of torque from the differential output shaft 50. Although, the present disclosure describes the differential output shaft 50 and the extension shaft 86 as two separate and individual components, it may be contemplated that the differential output shaft 50 and the extension shaft 86 can be an integrated component of the drive assembly 26.

The clutch 66 is an electro-hydraulic brake arrangement mounted on the tandem housing 52 and positioned along a periphery of the second ring gear 82. The clutch 66 is adapted to at least partially engage and disengage with the second ring gear 82, to correspondingly at least partially restrict and allow the rotational motion of the second ring gear 82. Therefore, the clutch 66 switches the second ring gear 82 between the free state and the partially restricted state. Although, the clutch 66 is described as the electro-hydraulic brake arrangement, various other types of the clutch 66 may also be contemplated. Examples of the clutch 66 may include, such as but not limited to, a pneumatic clutch, a hydraulic clutch, and an electric clutch.

In the current embodiment, the second planetary carrier 84 of the secondary planetary gear assembly 64 is fixedly attached to the base member 56 (FIG. 3) of the Wheel drive mechanism 54. In the free state of the second ring gear 82, the second planetary carrier 84 receives minimal amount of torque from the differential output shaft 50 and therefore the base member 56 of the wheel drive mechanism 54 is powered by the first planetary carrier 74 of the primary planetary gear assembly 62. In the partially restricted state of the second ring gear 82, the second planetary carrier 84 of the secondary planetary gear assembly 64 receives substantial amount of torque form the differential output shaft 50. The second planetary carrier 84 transmits this torque to the base member 56 (FIG. 3), in the partially restricted state of the second ring gear 82. Therefore, the second planetary carrier 84 applies additional torque to the base member 56 (FIG. 3) of the wheel drive mechanism 54 and correspondingly the rear wheels 18, in the partially restricted state of the second ring gear 82.

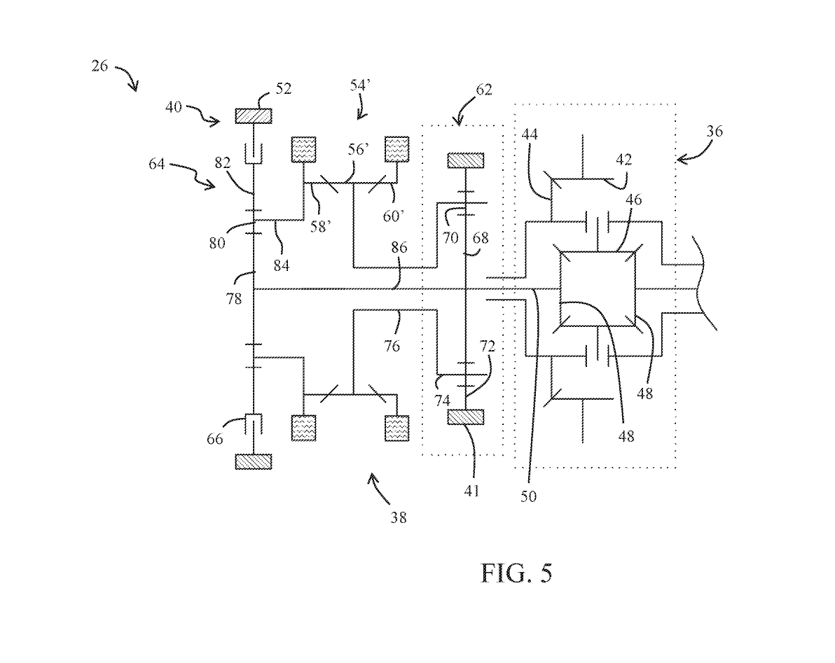

Referring to FIG. 5, an alternate embodiment of the wheel drive mechanism 54′ of the tandem 38 is shown, in accordance with the concepts of the present disclosure. In the alternate embodiment, the wheel drive mechanism 54′ includes a base member 56′, a first chain member 58′, and a second chain member 60′. The base member 56′, the first chain member 58′ and the second chain member 60′ are gear members arranged in form of a differential arrangement. More specifically, each of the first chain member 58′ and the second chain member 60′ are meshed with the base member 56′. In the alternate embodiment, the first planetary carrier 74 of the primary planetary gear assembly 62 is attached to the base member 56′ and the second planetary carrier 84 of the secondary planetary gear assembly 64 is attached to the first chain member 58′ of the wheel drive mechanism 54. This arrangement facilitates an additional degree of freedom to the drive assembly 26, which in turn facilitates the secondary planetary gear assembly 64 to supply additional torque to the rear wheels 18, even in a fully restricted state of the second ring gear 82. More specifically, in the fully restricted state of the second ring gear 82, the second planetary carrier 84 drives one of the rear wheels 18 with a relatively higher speed than the other of the rear wheels 18, installed on the first side 32 of the motor grader 10.

### INDUSTRIAL APPLICABILITY

In operation, the motor grader 10 is maneuvered on the ground surface, to level the ground surface during grading operation. In a normal mode of operation of the motor grader 10, the blade 20 is positioned laterally on the motor grader 10. In such situations, the rear wheels 18 installed on each of the first side 32 and the second side 34 are required to receive equal amount of torque. Therefore, in the normal mode of operation, the clutch 66 of the final drive arrangement 40 are kept disengaged from the second ring gear 82, on each of the first side 32 and the second side 32 of the motor grader 10. In this position, the wheel drive mechanism 54, 54′ is driven by the differential output shaft 50, via the primary planetary gear assembly 62 of the final drive arrangement 40. The wheel drive mechanism 54, 54′, in turn, rotates the rear wheels 18 to maneuver the motor grader 10 forward. Furthermore, in side-loaded operating conditions of the motor grader 10, the blade 20 is positioned at an angle relative to the motion of the motor grader 10. To counteract the side load in such situations, the rear wheels 18 are required to receive relatively higher torque on one of the first side 32 and the second side 34, relative to the other of the first side 32 and the second side 34. For example, the rear wheels 18 installed on the first side 32 may require to receive relatively higher torque, than the rear wheels 18 installed on the second side 34. In order to facilitate this selective torque transmission, the clutch 66 of the final drive arrangement 40 installed on the first side 32, is initially triggered by a control system (not shown). As the clutch 66 of the final drive arrangement 40 is triggered, the clutch 66 partially engages with the second ring gear 82. This causes the second ring gear 82 to be adjusted to the partially restricted state. In the partially restricted state of the second ring gear 82, the second planetary carrier 84 of the secondary planetary gear assembly 64 receives substantial amount of torque from the second sun gear 78. The second planetary carrier 84 then transfers this torque to the base member 56, 56′ of the wheel drive mechanism 54, 54′. This adds on to torque received by the base member 56, 56′ of the wheel drive mechanism 54, 54′, to drive the rear wheels 18 installed on the first side 32 of the motor grader 10. Therefore, the rear wheels 18 installed on the first side 32 of the motor grader 10 receives a relatively higher torque than the rear wheels 18 installed on the second side 34 of the motor grader 10. Notably, negligible power is wasted, while facilitating the selective torque transmission to the rear wheels 18 in the disclosed drive assembly 26. Additionally, this arrangement avoids continuous human effort, to facilitate torque vectoring. This increases the overall efficiency of the drive assembly 26, to facilitate torque vectoring in the rear wheels 18 of the motor grader 10.

The many features and advantages of the disclosure are apparent from the detailed specification, and thus, it is intended by the appended claims to cover all such features and advantages of the disclosure that fall within the true spirit and scope thereof. Further, since numerous modifications and variations will readily occur to those skilled in the art. It is not desired to limit the disclosure to the exact construction and operation illustrated and described, and, accordingly, all suitable modifications and equivalents may be resorted to that fall within the scope of the disclosure.

What is claimed is:

1. A drive assembly for a machine, the drive assembly comprising:
a differential gear arrangement including at least one differential output shaft; and
at least one final drive arrangement connected to and driven by the at least one differential output shaft, the at least one final drive arrangement comprising:
a primary planetary gear assembly including a first sun gear, one or more first planetary gears, a first ring gear, and a first planetary carrier, wherein the first ring gear is stationary, the first sun gear is connected to and powered by the at least one differential output shaft, and the first planetary carrier is fixedly connected to a wheel drive mechanism;
a secondary planetary gear assembly including a second sun gear, one or more second planetary gears, a second ring gear, and a second planetary carrier,
wherein the secondary planetary gear assembly possesses a different gear ratio relative to the primary planetary gear assembly, the second sun gear is connected to and powered by the at least one differential output shaft, and the second planetary carrier is fixedly connected to the wheel drive mechanism; and
a clutch adapted to at least partially engage and disengage with the second ring gear, to correspondingly at least partially restrict and release the second ring gear of the secondary planetary gear assembly.
